(19) United States
(12) Patent Application Publication
(10) Pub. No.: US 2026/0195177 A1
(43) Pub. Date: Jul. 9, 2026

(54) SYSTEMS AND METHODS FOR OPTIMAL MODEL DECOMPOSITION

(71) Applicant: Dell Products L.P., Round Rock, TX (US)

(72) Inventors: Jake M. LELAND, Round Rock, TX (US); Ryan N. COMER, Round Rock, TX (US); Robert C. HERNANDEZ, Morrisville, NC (US); Tyler R. COX, Austin, TX (US)

(73) Assignee: Dell Products L.P., Round Rock, TX (US)

(21) Appl. No.: 19/012,379

(22) Filed: Jan. 7, 2025

(51) Int. Cl. G06F 9/50

(52) U.S. Cl. CPC G06F 9/5016

(57) ABSTRACT

An information handling system may include a memory and a processor communicatively coupled to the memory, and configured to model an artificial intelligence model as a graph, select a cost function for assigning a cost value for each edge of the graph, and select a demand function for assigning a demand value between each pair of nodes of the graph. The processor may also be configured to, for each cut of a plurality of possible cuts to the graph, calculate a sparsity of each cut based on the cost value and the demand value corresponding to such cut, determine a sparsest cut of the plurality of cuts as a cut having a smallest sparsity among the sparsities of the plurality of possible cuts, and split the artificial intelligence model into a plurality of fragments based on the sparsest cut.

### TECHNICAL FIELD

The present disclosure relates in general to information handling systems, and more particularly to methods and systems for optimal decomposition of an artificial intelligence model across compute nodes.

### BACKGROUND

s the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are increasingly used for artificial intelligence. Artificial intelligence, in its broadest sense, is intelligence exhibited by machines, particularly information handling systems. Artificial intelligence is a field of research in computer science that develops and studies methods and software that enable machines to perceive their environment and use learning and intelligence to take actions that maximize their chances of achieving defined goals. Artificial intelligence models are executable programs that detect specific patterns using a collection of data sets. A model may be thought of as an illustration of a system that can receive data inputs and draw conclusions or conduct actions depending on those conclusions. An example of an artificial model is a neural network, which may be a model that makes decisions in a manner similar to the human brain, by using processes that mimic the way biological neurons work together to identify phenomena, weigh options and arrive at conclusions.

As advancements in artificial intelligence infrastructure continue to enable more client-friendly form factors, artificial intelligence model deployments are rapidly diversifying from cloud computing environments to edge computing environments. Artificial intelligence-enabled enterprises have increasingly more freedom to choose where their workloads run, often selecting local and edge deployments for the sake of cost and data protection. However, edge environments present unique challenges. Complexities arise due to the diversity of heterogeneous nodes and their distinct limitations in compute, memory, networking, and operator support.

Enterprises are eager to incorporate artificial intelligence, including generative artificial intelligence, into their everyday toolkits, and as adoption continues to increase, many administrators are looking toward their edge resources to provide a more responsive, more secure, and more cost-efficient execution environment for their artificial intelligence workloads. However, foundation models often have compute and memory demands which exceed any single node.

### SUMMARY

In accordance with the teachings of the present disclosure, the disadvantages and problems associated with existing approaches to deployment of artificial intelligence workloads may be reduced or eliminated.

In accordance with embodiments of the present disclosure, an information handling system may include a memory and a processor communicatively coupled to the memory, and configured to model an artificial intelligence model as a graph, select a cost function for assigning a cost value for each edge of the graph, and select a demand function for assigning a demand value between each pair of nodes of the graph. The processor may also be configured to, for each cut of a plurality of possible cuts to the graph, calculate a sparsity of each cut based on the cost value and the demand value corresponding to such cut, determine a sparsest cut of the plurality of cuts as a cut having a smallest sparsity among the sparsities of the plurality of possible cuts, and split the artificial intelligence model into a plurality of fragments based on the sparsest cut.

In accordance with these and other embodiments of the present disclosure, a method may include modeling an artificial intelligence model as a graph, selecting a cost function for assigning a cost value for each edge of the graph and selecting a demand function for assigning a demand value between each pair of nodes of the graph. The method may also include for each cut of a plurality of possible cuts to the graph, calculating a sparsity of each cut based on the cost value and the demand value corresponding to such cut, determining a sparsest cut of the plurality of cuts as a cut having a smallest sparsity among the sparsities of the plurality of possible cuts, and splitting the artificial intelligence model into a plurality of fragments based on the sparsest cut.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to: (i) model an artificial intelligence model as a graph; (ii) select a cost function for assigning a cost value for each edge of the graph; (iii) select a demand function for assigning a demand value between each pair of nodes of the graph; (iv) for each cut of a plurality of possible cuts to the graph, calculate a sparsity of each cut based on the cost value and the demand value corresponding to such cut; (v) determine a sparsest cut of the plurality of cuts as a cut having a smallest sparsity among the sparsities of the plurality of possible cuts; and (vi) split the artificial intelligence model into a plurality of fragments based on the sparsest cut.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for executing artificial intelligence workloads, in accordance with embodiments of the present disclosure;

FIG. 2 illustrates a flow chart of an example method for static decomposition of an artificial intelligence model, in accordance with embodiments of the present disclosure;

FIG. 3 illustrates a flow chart of an example method for dynamic decomposition of an artificial intelligence model, in accordance with embodiments of the present disclosure;

FIG. 4 illustrates an example graph, representing an artificial intelligence model, in accordance with embodiments of the present disclosure;

FIG. 5 illustrates the example graph of FIG. 4 with a cost value of 1 assigned to each edge and a demand value of 1 assigned between each pair of nodes, in accordance with embodiments of the present disclosure;

FIG. 6 illustrates another example graph, representing another artificial intelligence model, in accordance with embodiments of the present disclosure;

FIG. 7 illustrates yet another example graph, representing yet another artificial intelligence model, in accordance with embodiments of the present disclosure;

FIG. 8 illustrates yet another example graph, representing yet another artificial intelligence model, in accordance with embodiments of the present disclosure;

FIG. 9 illustrates yet another example graph, representing yet another artificial intelligence model, in accordance with embodiments of the present disclosure;

FIG. 10 illustrates yet another example graph, representing yet another artificial intelligence model, in accordance with embodiments of the present disclosure; and

FIG. 11 illustrates yet another example graph, representing yet another artificial intelligence model, in accordance with embodiments of the present disclosure.

### DETAILED DESCRIPTION

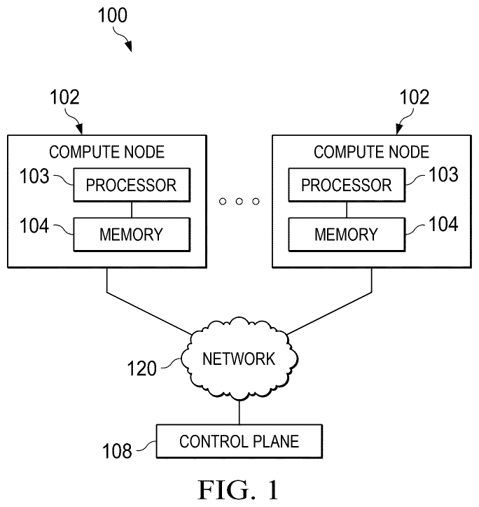

Preferred embodiments and their advantages are best understood by reference to FIGS. 1 through 11, wherein like numbers are used to indicate like and corresponding parts. For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example system 100 for executing artificial intelligence workloads, in accordance with embodiments of the present disclosure. As shown in FIG. 1, system 100 may include a plurality of compute nodes 102, a control plane 108, and a network 120.

Each compute node 102 may comprise an information handling system, as defined above. In operation, each compute node 102 may be configured to execute an artificial intelligence workload using the processing and memory resources thereof. The various compute nodes 102 in system 100 may represent different types of information handling systems within an enterprise. For example, one or more of compute nodes 102 may comprise servers, one or more of compute nodes 102 may comprise client information handling systems (e.g., a laptop, notebook, tablet, handheld, smart phone, personal digital assistant, etc.), one or more of compute nodes 102 may comprise edge devices, and one or more of compute nodes 102 may comprise cloud computing resources.

As depicted in FIG. 1, each compute node may include a processor 103, and a memory 104 communicatively coupled to processor 103.

Processor 103 may include any system, device, or apparatus configured to interpret and/or execute program instructions and/or process data, and may include, without limitation, a microprocessor, microcontroller, digital signal (DSP), application specific integrated circuit processor (ASIC), graphics processing unit (GPU), neural processing unit (NPU), or any other digital or analog circuitry configured to interpret and/or execute program instructions and/or process data. In some embodiments, processor 103 may interpret and/or execute program instructions and/or process data stored in memory 104 and/or another component of a compute node 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to compute node 102 is turned off.

In operation, memory 104 may store all or a portion of an artificial intelligence model, data associated with the model, and executable instructions which may be read and executed by processor 103 to process the data in accordance with the model.

For purposes of clarity and exposition, each compute node 102 is depicted as only including a processor 103 and a memory 104. However, each compute node 102 may comprise other information handling resources not explicitly depicted in FIG. 1.

Control plane 108 may comprise any system, device, or apparatus configured to manage and control execution of artificial intelligence models on the various compute nodes 102. Accordingly, control plane 108 may execute one or more services, including an orchestrator service, for decomposing models for execution among the various compute nodes 102, as described in greater detail below. In some embodiments, control plane 108 may comprise an information handling system distinct from compute nodes 102. In other embodiments, control plane 108 may be a part of and/or executed by one of compute nodes 102. Although not shown in FIG. 1, control plane 108 may also include a processor (e.g., similar to processor 103), memory (e.g., similar to memory 104) and other information handling resources.

Network 120 may comprise a network and/or fabric configured to communicatively couple compute nodes 102 and control plane 108 to each other and/or one or more other information handling systems. In these and other embodiments, network 120 may include a communication infrastructure, which provides physical connections, and a management layer, which organizes the physical connections and information handling systems communicatively coupled to network 120. Network 120 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 120 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 120 and its various components may be implemented using hardware, software, or any combination thereof.

In operation, control plane 108 may decompose artificial intelligence models based on one or more key heuristics. These heuristics may vary according to the heterogenous environment of system 100 and the rationale for splitting the model. For example, control plane 108 may (1) decompose a model across nodes due to memory constraints, (2) decompose a model across local and cloud nodes for the purpose of privacy or personalization, or (3) decompose a model due to limited operator support across compute nodes. In every case, the point(s) at which the model is split may also minimize the amount of data transferred in order to minimize network traffic.

At a fundamental level, models implemented as neural networks are graphs. The systems and methods disclosed herein may determine an optimal location to split a neural network graph cut based on dynamically configured cost functions. The systems and methods of the present disclosure may manipulate these cost functions to achieve desired graph decomposition. The systems and methods may be employed by a user pre-processing a model or may be initiated dynamically by an orchestration system upon receiving a new model workload. In both cases, inputs defining the constraints of the system (user-configured or inferred by an orchestrator) may steer the algorithm in producing a model optimally partitioned for the environment.

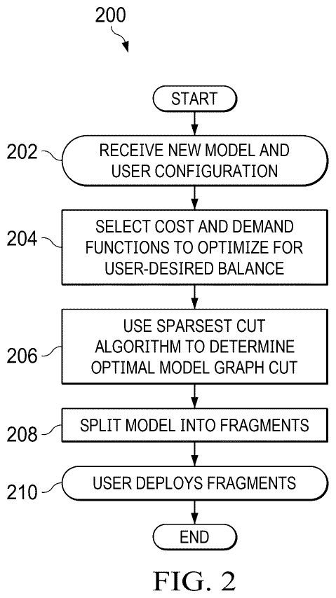

FIG. 2 illustrates a flow chart of an example method 200 for static decomposition of an artificial intelligence model, in accordance with embodiments of the present disclosure. According to some embodiments, method 200 may begin at step 202. As noted above, teachings of the present disclosure may be implemented in a variety of configurations of system 100. As such, the preferred initialization point for method 200 and the order of the steps comprising method 200 may depend on the implementation chosen.

At step 202, control plane 108 may receive a new artificial intelligence model and a user configuration, which may include user preferences regarding execution of the artificial intelligence model.

At step 204, control plane 108 may select a cost function and a demand function to optimize decomposition consistent with user preferences. The selection of cost functions and demand functions is explained in greater detail elsewhere in this disclosure.

At step 206, control plane 108 may employ a sparsest cut algorithm based on the cost function and the demand function to determine an optimal location to split a graph representing the model. At step 208, control plane 108 may split the model into a plurality of fragments based on the location of the split. At step 210, a user may deploy the fragments to different compute nodes 102 in accordance with the suggested model split such that each of the plurality of fragments execute on different compute nodes 102. After completion of step 210, method 200 may end.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using a variety of configurations of system 100 and/or any other system operable to implement method 200. In certain embodiments, method 200 may be implemented partially or fully in software and/or firmware embodied in computer-readable media.

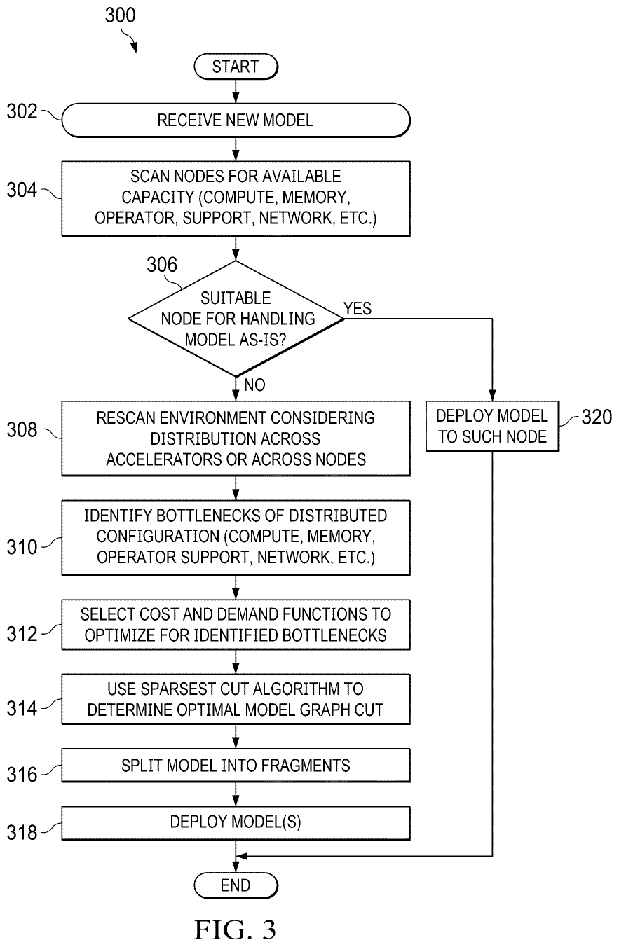

FIG. 3 illustrates a flow chart of an example method 300 for dynamic decomposition of an artificial intelligence model, in accordance with embodiments of the present disclosure. According to some embodiments, method 300 may begin at step 302. As noted above, teachings of the present disclosure may be implemented in a variety of configurations of system 100. As such, the preferred initialization point for method 300 and the order of the steps comprising method 300 may depend on the implementation chosen.

At step 302, control plane 108 may receive a new artificial intelligence model. At step 304, control plane 108 may scan the various compute nodes 102 to determine if and which compute nodes have available capacity for execution of the model. Such scanning of compute nodes 102 may determine the processing resources, memory capacity, operator support, and/or network capacity.

At step 306, if a suitable compute node 102 is found capable of executing the new model as-is, method 300 may proceed to step 320. Otherwise, method 300 may proceed to step 308.

At step 308, control plane 108 may rescan system 100 considering distribution of artificial intelligence workload across accelerators or across compute nodes 102. At step 310, based on the rescan, control plane 108 may identify bottlenecks in execution, considering processing resources, memory capacity, operator support, and/or network capacity of compute nodes 102.

At step 312, control plane 108 may select a cost function and a demand function to optimize decomposition in a manner that reduces the identified bottlenecks. The selection of cost functions and demand functions is explained in greater detail elsewhere in this disclosure.

At step 314, control plane 108 may employ a sparsest cut algorithm based on the cost function and the demand function to determine an optimal location to split a graph representing the model. At step 316, control plane 108 may split the model into a plurality of fragments based on the location of the split. At step 318, control plane 108 may deploy the fragments to different compute nodes 102 such that each of the plurality of fragments execute on different compute nodes 102. After completion of step 318, method 300 may end.

At step 320, control plane 108 may deploy the model to the compute node 102 capable of executing the model as-is. After completion of step 320, method 300 may end.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented in whole or part using a variety of configurations of system 102 and/or any other system operable to implement method 300. In certain embodiments, method 300 may be implemented partially or fully in software and/or firmware embodied in computer-readable media.

In order to execute steps 204 and 206 of method 200 and steps 312 and 314 of method 300 described above, control plane 108 may select a cost function, select a demand function, and then apply a sparsest cut algorithm to the cost function and the demand function to determine an optimum location to split a model. For a given weighted graph G=(V,E), which may represent an artificial intelligence model, the sparsity Φ of a cut or split S⊆V may be defined as:

$$Φ ( S ) = \frac{c ( S , \overline{S} )}{D ( S , \overline{S} )}$$

where a cost function c may be given by:

$$c ( S , \overline{S} ) = {\sum }_{e across S , \overline{S}} c ( e )$$

and demand function D may be given by:

$$D ( S , \overline{S} ) = {\sum }_{s ∈ s , t ∈ \overline{S}} D ( s , t )$$

To optimize a location of a graph split for an artificial intelligence model, control plane 108 may find the sparsest cut S* in the graph G which minimizes Φ:

$${Φ}^{*} = Φ ( {S}^{*} ) = {min}_{s ⊆ V} Φ ( S )$$

Every edge e of graph G may have a cost (or weight/capacity) value determined by cost function c(e) and every pair of vertices (s,t) in graph G may have a demand (or requirement) value determined by a demand function D(s,t). Thus, control plane 108 attempts to minimize cost and maximize demand by finding the sparsest cut S* in the graph G which minimizes Φ. Consequently, how the cost and demand functions are defined may dictate how the optimal split location is determined.

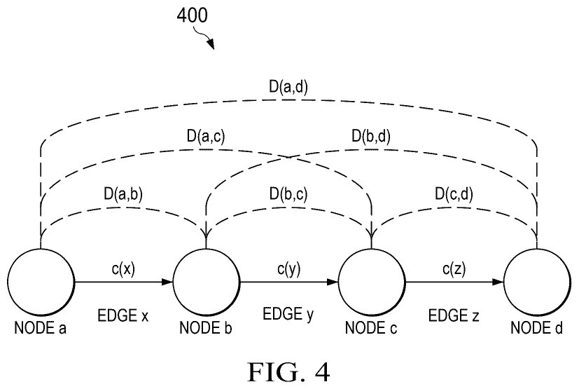

To further illustrate, FIG. 4 illustrates an example graph 400, representing an artificial intelligence model, in accordance with embodiments of the present disclosure. Graph 400 is depicted having four nodes (nodes a, b, c, d), a cost c(x) on an edge between node a and node b, a cost c(y) on an edge between node b and node c, and a cost c(z) on an edge between node c and node d. Graph 400 also has a demand D(a,b) between node a and node b, a demand D(a,c) between node a and node c, a demand D(a,d) between node a and node d, a demand D(b,c) between node b and node c, a demand D(b,d) between node b and node d, and a demand D(c,d) between node c and node d.

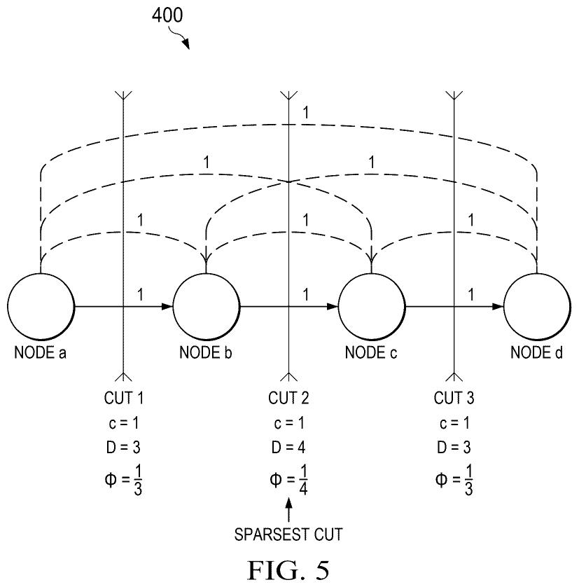

FIG. 5 illustrates graph 400, but with a cost value of 1 assigned to each edge (i.e., c(x)=c(y)=c(z)=1) and a demand value of 1 between each pair of nodes (i.e., D(a,b)=D(a,c)=D(a,d)=D(b,c)=D(b,d)=D(c,d)=1). FIG. 5 also illustrates possible cuts of graph 400 with such values, including Cut 1, Cut 2, and Cut 3. Cut 1 and cut 3 each have a cost of 1 with a demand of 3, meaning the sparsity of each of Cuts 1 and 3 is ⅓. Cut 2 has a cost of 1 with a demand of 4, meaning the sparsity of Cut 2 is ¼. Accordingly, in the simplified example of FIG. 5, Cut 2 is the sparsest cut.

The concept depicted in FIGS. 4 and 5 may be applied to even more complex graphs/artificial intelligence models, and cost functions and demand functions may be selected to optimize different parameters.

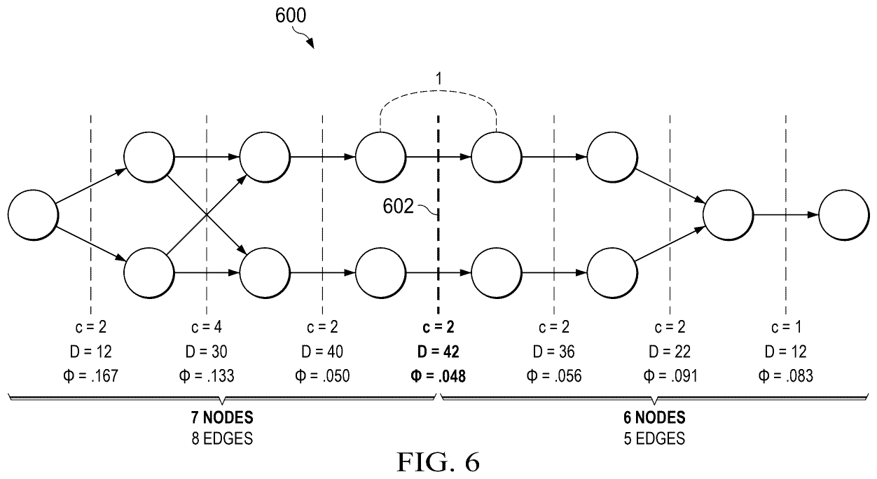

For example, FIG. 6 illustrates an example graph 600, representing an artificial intelligence model, in accordance with embodiments of the present disclosure. In the example of FIG. 6, a cost value of 1 may be assigned to each edge and a demand value of 1 may be assigned between each pair of nodes. With these cost and demand functions, control plane 108 may optimize graph 600 by splitting graph 600 at cut 602. Because execution of model operations may be represented by nodes of graph 600, the sparsest cut of graph 600 may evenly balance compute demand between compute nodes 102.

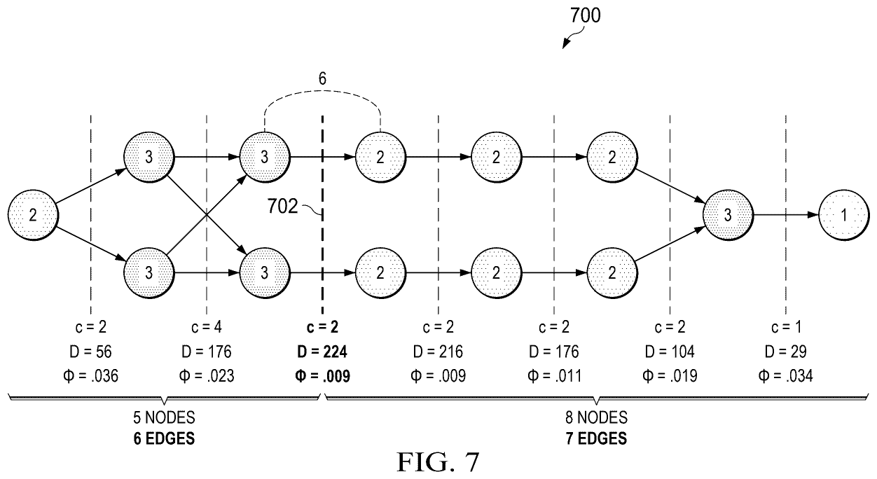

As another example, FIG. 7 illustrates an example graph 700, representing an artificial intelligence model, in accordance with embodiments of the present disclosure. In the example of FIG. 7, a cost value of 1 may be assigned to each edge but the demand D between each set of nodes of graph 700 may be given by D(s,t)=deg(s)*deg(t), where the degree deg of a node equals the number of incident edges a node has (and which degree deg is set forth within the circles representing the nodes). With these cost and demand functions, control plane 108 may optimize graph 700 by splitting graph 700 at cut 702. Because model parameters such as weights and biases may be associated with edges of graph 700, the sparsest cut of graph 700 may evenly balance memory usage among nodes 102. In FIG. 7, so as to not overwhelm FIG. 7, not all demand connections are shown and only one demand connection between one pair of nodes is shown.

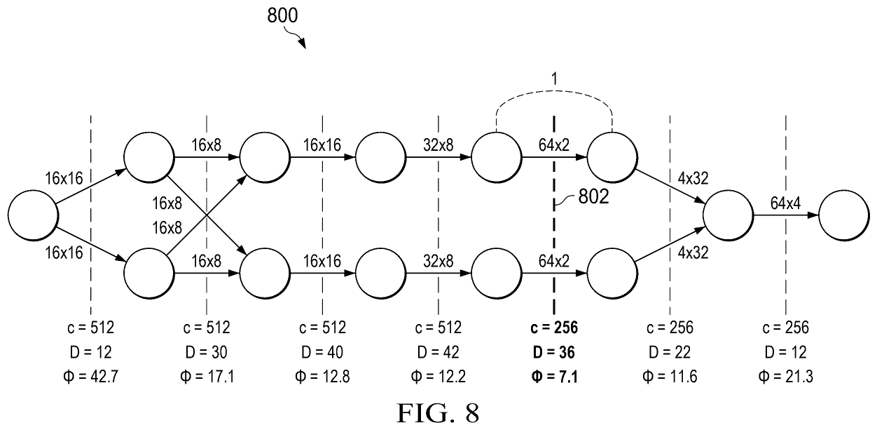

As yet another example, FIG. 8 illustrates an example graph 800, representing an artificial intelligence model, in accordance with embodiments of the present disclosure. In the example of FIG. 8, the cost c of each edge may be given by c(e)=size(e), wherein the size of an edge may be determined by the shape and type of the data passing along the edge. Example edge sizes are shown in FIG. 8 as the product of two numbers, which may represent the size of a data matrix passed along the edge between nodes. Further, a demand value of 1 may be assigned between each pair of nodes. With these cost and demand functions, control plane 108 may optimize graph 800 by splitting graph 800 at cut 802. Because data is transferred across edges, the sparsest cut of graph 800 may minimize load on network 120.

Notably, graphs 600, 700, and 800 of FIGS. 6, 7, and 8, respectively, may share the exact same model architecture. The only difference may be definitions of the cost and demand functions. The cost and demand functions selected in FIG. 6 may result in a cut such that the compute demand of the two fragments is most balanced. The cost and demand functions selected in FIG. 7 may result in a cut such that the memory usage of the two fragments is most balanced. The cost and demand functions selected in FIG. 8 may result in a cut such that the network transfer between the two fragments is minimized. This is further emphasized in FIGS. 6-8 via the brackets underneath the graph with node and edge counts.

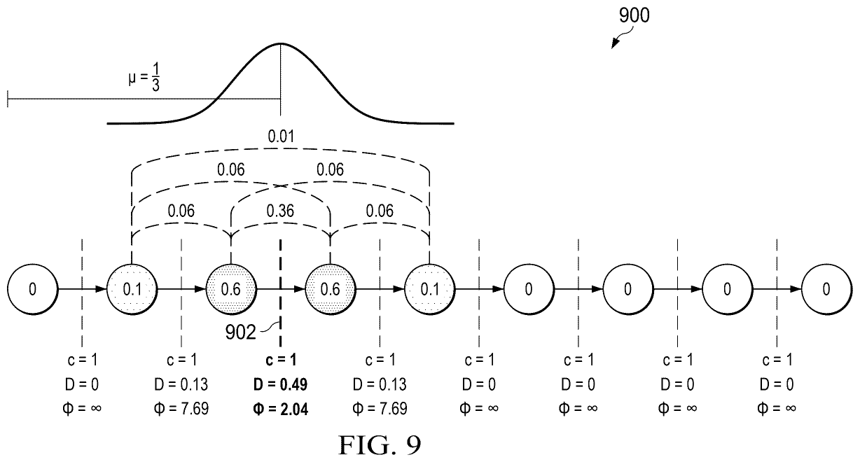

As a further example, FIG. 9 illustrates an example graph 900, representing an artificial intelligence model, in accordance with embodiments of the present disclosure. In the example of FIG. 9, a cost value of 1 may be assigned to each edge but the demand D between each set of nodes of graph 900 may be given by the complex function:

$$D ( s , t ) = {φ}_{μ , {σ}^{2}} ( \frac{layer ( s )}{\# layers - 1} ) * {φ}_{μ , {σ}^{2}} ( \frac{layer ( t )}{\# layers - 1} )$$

φ_{μ,σ}² may comprise the normal probability density function, with the parameter μ controlling the split location of graph 900 and the parameter σ² controlling flexibility. The quantity

$$( \frac{layer ( t )}{\# layers - 1} )$$

may define a fractional depth of a node with layers of the model. The result of

$${φ}_{μ , {σ}^{2}} ( \frac{layer ( s )}{\# layers - 1} )$$

for each node is illustrated in FIG. 9 as the number within each circle representing a node. Thus the overall result of demand function D(s,t) is the multiplication between each pair of nodes, as shown on the dotted demand lines in FIG. 9.

While parameter μ may have any value, an exemplary value of parameter μ=⅓ has been chosen for graph 900 of FIG. 9, for the purposes of exposition. With parameter μ=⅓ control plane 108 may optimize graph 900 by splitting graph 900 at cut 902. Use cases for the approach of FIG. 9 may include situations in which data privacy is a concern. For example, in a model that processes sensitive data, the model may be split such that the first x layers of the model run local to a user such that the user's data is kept on the user's device. Another use case for the approach of FIG. 9 may include situations in which some personalization may be desired for the model. For example, a model may have custom per-user weights, and it may be desirable to separate the last x layers of the model run local to a user.

The outcome of using the demand function set forth above for graph 900 is that the sparsest cut algorithm may be most incentivized to cut graph 900 in the middle of the probability density function. This concept is what the overlay of the normal distribution along graph 900 is intended to represent in FIG. 9.

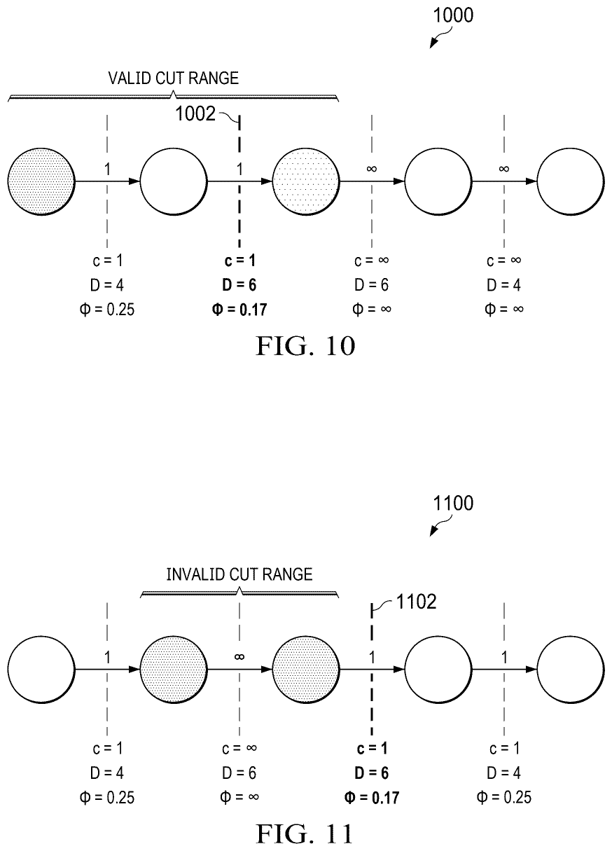

As a further example, FIG. 10 illustrates an example graph 1000, representing an artificial intelligence model, in accordance with embodiments of the present disclosure. In the example of FIG. 10, a cost value of ∞ may be assigned to each edge outside a valid cut range and to each edge inside an invalid cut range, with a cost value of 1 assigned to all other edges and a demand value of 1 assigned between each pair of nodes. Valid and invalid cut ranges may exist where certain model operators may only execute on certain nodes in a graph. With these cost and demand functions, control plane 108 may optimize graph 1000 by splitting graph 1000 at cut 1002, such that the sparsest cut occurs within the valid cut range.

As a further example, FIG. 11 illustrates an example graph 1100, representing an artificial intelligence model, in accordance with embodiments of the present disclosure. In the example of FIG. 11, the cost function and demand functions may be the same as that for graph 1000 of FIG. 10. With these cost and demand functions, control plane 108 may optimize graph 1100 by splitting graph 1100 at cut 1102, such that the sparsest cut occurs outside the invalid cut range.

Use cases for the approach of FIGS. 10 and 11 may be situations in which certain artificial intelligence operators may be unsupported or suboptimal in the environments of certain compute nodes 102.

It is noteworthy in FIGS. 6-10 that the choice of cost and demand equations has an impact on how a graph is cut. If control plane 108 is aware of which factors are most important when splitting a model, control plane 108 may choose cost and demand functions that are known to optimize for that result. For example, in terms of graph 600 of FIG. 6, each of the cost and demand functions to 1 may have the effect of causing the sparsest cut algorithm to cut the graph in such a way that the compute demand is balanced between the two fragments.

Further, in some instances, the cost and demand functions illustrated in the foregoing figures may be combined to account for multiple optimization considerations. For example, a scenario for splitting a model may be to balance memory usage (e.g., as in FIG. 7), but since nodes may be coupled via a network, it may also be beneficial to minimize the data transfer over the network (e.g., as in FIG. 8). Thus, in such a scenario, the cost and demand functions from the embodiments of FIGS. 7 and 8 may be combined, which may result in the sparsest cut algorithm making its best attempt to satisfy both constraints.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S. C. § 112(f) unless the words “means for” or “step for” are explicitly used in the particular claim.

What is claimed is:

1. An information handling system comprising:
a memory; and
a processor communicatively coupled to the memory, and configured to:
model an artificial intelligence model as a graph;
select a cost function for assigning a cost value for each edge of the graph;
select a demand function for assigning a demand value between each pair of nodes of the graph;
for each cut of a plurality of possible cuts to the graph, calculate a sparsity of each cut based on the cost value and the demand value corresponding to such cut;
determine a sparsest cut of the plurality of cuts as a cut having a smallest sparsity among the sparsities of the plurality of possible cuts; and
split the artificial intelligence model into a plurality of fragments based on the sparsest cut.

2. The information handling system of claim 1, wherein either or both of selecting the cost function and selecting the demand function are based on a user configuration associated with the artificial intelligence model.

3. The information handling system of claim 1, wherein either or both of selecting the cost function and selecting the demand function are based on optimizing identified bottlenecks associated with the artificial intelligence model.

4. The information handling system of claim 1, wherein either or both of the cost function and the demand function are selected to balance memory utilization among the plurality of compute nodes.

5. The information handling system of claim 1, wherein either or both of the cost function and the demand function are selected to balance computational demand among the plurality of compute nodes.

6. The information handling system of claim 1, wherein either or both of the cost function and the demand function are selected to minimize network utilization required to execute the artificial intelligence model among the plurality of compute nodes.

7. The information handling system of claim 1, wherein either or both of the cost function and the demand function are selected to ensure execution of one or more layers of the artificial intelligence model on a particular compute node of the plurality of compute nodes.

8. The information handling system of claim 1, wherein either or both of the cost function and the demand function are selected to ensure execution of one or more operators of the artificial intelligence model on a particular compute node of the plurality of compute nodes which supports execution of the operator.

9. A method comprising:
modeling an artificial intelligence model as a graph;
selecting a cost function for assigning a cost value for each edge of the graph;
selecting a demand function for assigning a demand value between each pair of nodes of the graph;
for each cut of a plurality of possible cuts to the graph, calculating a sparsity of each cut based on the cost value and the demand value corresponding to such cut;
determining a sparsest cut of the plurality of cuts as a cut having a smallest sparsity among the sparsities of the plurality of possible cuts; and
splitting the artificial intelligence model into a plurality of fragments based on the sparsest cut.

10. The method of claim 9, wherein either or both of selecting the cost function and selecting the demand function are based on a user configuration associated with the artificial intelligence model.

11. The method of claim 9, wherein either or both of selecting the cost function and selecting the demand function are based on optimizing identified bottlenecks associated with the artificial intelligence model.

12. The method of claim 9, wherein either or both of the cost function and the demand function are selected to balance memory utilization among the plurality of compute nodes.

13. The method of claim 9, wherein either or both of the cost function and the demand function are selected to balance computational demand among the plurality of compute nodes.

14. The method of claim 9, wherein either or both of the cost function and the demand function are selected to minimize network utilization required to execute the artificial intelligence model among the plurality of compute nodes.

15. The method of claim 9, wherein either or both of the cost function and the demand function are selected to ensure execution of one or more layers of the artificial intelligence model on a particular compute node of the plurality of compute nodes.

16. The method of claim 9, wherein either or both of the cost function and the demand function are selected to ensure execution of one or more operators of the artificial intelligence model on a particular compute node of the plurality of compute nodes which supports execution of the operator.

17. An article of manufacture comprising:
a non-transitory computer-readable medium; and
computer-executable instructions carried on the computer-readable medium, the instructions readable by a processor, the instructions, when read and executed, for causing the processor to:
model an artificial intelligence model as a graph;
select a cost function for assigning a cost value for each edge of the graph;
select a demand function for assigning a demand value between each pair of nodes of the graph;
for each cut of a plurality of possible cuts to the graph, calculate a sparsity of each cut based on the cost value and the demand value corresponding to such cut;
determine a sparsest cut of the plurality of cuts as a cut having a smallest sparsity among the sparsities of the plurality of possible cuts; and
split the artificial intelligence model into a plurality of fragments based on the sparsest cut.

18. The article of claim 17, wherein either or both of selecting the cost function and selecting the demand function are based on a user configuration associated with the artificial intelligence model.

19. The article of claim 17, wherein either or both of selecting the cost function and selecting the demand function are based on optimizing identified bottlenecks associated with the artificial intelligence model.

20. The article of claim 17, wherein either or both of the cost function and the demand function are selected to balance memory utilization among the plurality of compute nodes.

21. The article of claim 17, wherein either or both of the cost function and the demand function are selected to balance computational demand among the plurality of compute nodes.

22. The article of claim 17, wherein either or both of the cost function and the demand function are selected to minimize network utilization required to execute the artificial intelligence model among the plurality of compute nodes.

23. The article of claim 17, wherein either or both of the cost function and the demand function are selected to ensure execution of one or more layers of the artificial intelligence model on a particular compute node of the plurality of compute nodes.

24. The article of claim 17, wherein either or both of the cost function and the demand function are selected to ensure execution of one or more operators of the artificial intelligence model on a particular compute node of the plurality of compute nodes which supports execution of the operator.
